(19) United States
(12) Patent Application Publication
(10) Pub. No.: US 2014/0180772 A1
(43) Pub. Date: Jun. 26, 2014

(54) FINDING OBJECTS OR SERVICES UTILIZING A COMMUNICATION LINK TO ENLIST THE HELP OF AND REWARD THIRD PARTIES TO HELP LOCATE THE DESIRED OBJECT OR SERVICE

(71) Applicant: Tutupata, Inc., Paolo Alto, CA (US)

(72) Inventors: Adeline Fong, San Jose, CA (US); Michael K. Wilson, San Jose, CA (US)

(73) Assignee: Tutupata, Inc., Palo Alto, CA (US)

(21) Appl. No.: 14/095,873

(22) Filed: Dec. 3, 2013

Related U.S. Application Data
(60) Provisional application No. 61/733,383, filed on Dec. 4, 2012.

(51) Int. Cl. G06Q 30/06

(52) U.S. Cl. CPC G06Q 30/0627
USPC 705/12; 705/26.63

(57) ABSTRACT

A method and system for finding objects or services utilizing a communication link to enlist the help of and reward third parties to help locate the desired object or service.

### PRIORITY CLAIMS/RELATED APPLICATIONS

This application claims the benefit of and priority, under 35 USC 119(e) and 120, to U.S. Provisional Patent Application Ser. No. 61/733,383 filed on Dec. 4, 2012, and titled “Finding Objects Or Services Utilizing A Communication Link To Enlist The Help Of And Reward Third Parties To Help Locate The Desired Object Or Service”, the entirety of which is incorporated herein by reference.

### FIELD

The disclosure relates generally to a mechanism to located a desired object.

### BACKGROUND

Currently, most people who want to locate any object will do a search either manually or using a computer to try to locate the object. This technique works well for retail products that can be easily identified. However, such a system does not work well for hard to describe or unique products since the computer method requires key words which are difficult to determine for a hard to describe or unique product. It also fails because many products are not sold or even cataloged online, making them impossible to find through ‘traditional’ computer searches.

### BRIEF DESCRIPTION OF THE DRAWINGS

FIG. 1 is a diagram of an object finding environment;

FIG. 2 illustrates details of an implementation of a finder system;

FIG. 3 illustrates more details of the finder unit in the finder system in FIG. 2;

FIG. 4 illustrates an example of a method for finding an object that may be carried out by the system in FIG. 2;

FIG. 5 illustrates an example of the finder system user interface showing a list of wants;

FIG. 6 illustrates an example of the finder system user interface showing a detailed view of a list of wants;

FIG. 7 illustrates an example of the finder system user interface showing a detailed want for a particular item;

FIG. 8 illustrates an example of the finder system user interface for adding a want;

FIG. 9 illustrates an example of the finder system user interface of a list of wants;

FIG. 10 illustrates an example of the finder system user interface of a want and two finds for the wanted item;

FIG. 11 illustrates an example of the finder system user interface of a want with a voted down find;

FIG. 12 illustrates an example of the finder system user interface for accepting a find for a want;

FIG. 13 illustrates an example of the finder system user interface of a completed accepted find for a want;

FIG. 14 illustrates an example of the finder system user interface of a list of finds;

FIG. 15 illustrates an example of the finder system user interface showing a detailed view of a list of finds;

FIG. 16 illustrates an example of the finder system user interface showing a find with detailed location information;

FIG. 17 illustrates an example of the finder system user interface for adding a find;

FIGS. 18 and 19 illustrate an example of the finder system user interface for adding a find from ebay;

FIG. 20 illustrates an example of the finder system user interface for adding a find based on a store address; and

FIGS. 21-22 illustrate an example of the finder system user interface for “Want It!”.

### DETAILED DESCRIPTION OF ONE OR MORE EMBODIMENTS

The disclosure is particularly applicable to a finder system and method implemented in a client/server type architecture and it is in this context that the disclosure will be described. It will be appreciated, however, that the system and method has greater utility since the system may be implemented using cloud computing resources, in a software as a service (SaaS) model, in a standalone computer and the like. Furthermore, the system and method may be implemented in ways not specifically described below that are within the scope of this disclosure.

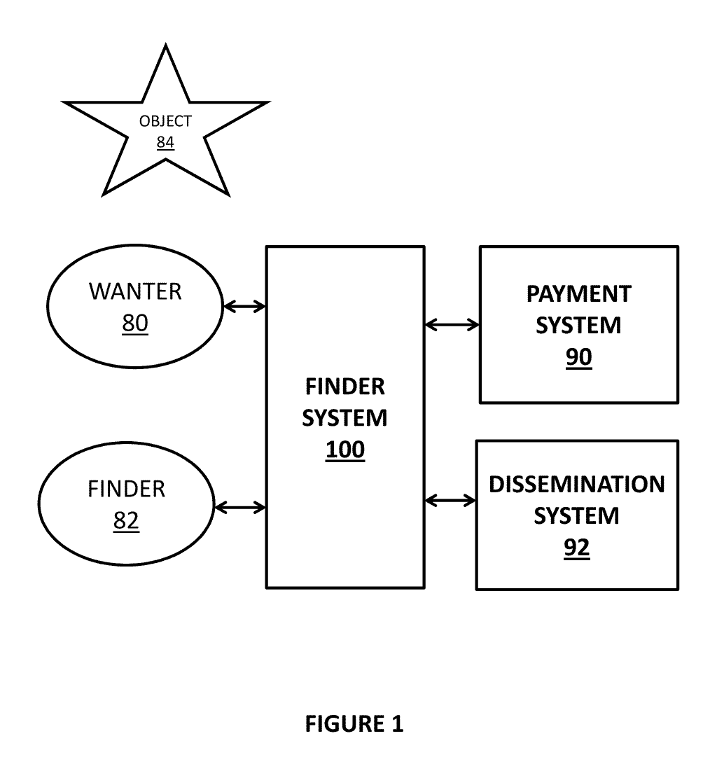

A method and system for finding objects or services utilizing a communication link to enlist the help of and reward third parties to help locate the desired object or service are provided. FIG. 1 is a diagram of an object finding environment in which an entity 80 (a wanter) wants an object 84 and a second entity 82 (a finder) is willing to locate the object for a tip/bounty being offered by the wanter. A finder system 100 may facilitate the interaction between the wanter and one or more finders to locate the object in which each of the wanter and the one or more finders may use a computing device to communicate and interact with the finder system 100. The object 84 may be a physical object, an electronic object, a service and the like. To facilitate the interaction between the wanter and the one or more finders, the finder system may incorporate a payment system 90 that manages the payment of the tip (a finder's fee) between the wanter and the finder who is chosen by the wanter and a dissemination system 92 that disseminates a want for an object to the one or more finders and receives finder data for the wanted object. In one implementation, the finder system 100 may be coupled to the payment system 90 and dissemination system 92 as shown in FIG. 1 and those systems may be controlled by a third party. For example, the payment system 90 may be any electronic payment system, such as Paypal for example, that allows the wanter and the selected finder to exchange the tip. For example, the dissemination system 92 may be an existing communication system for users of the finder system 100, a text messaging system, a social media system, an electronic mail, etc.

The finder system 100 allows a wanter who wants an object to describe that object and offer a finder's fee (tip or bounty), have the description of the wanted object and the value of the tip disseminated to one or more finders. The one or more finders may each try to locate the object (in a bid to receive the tip) and upload information about the located object to the finder system. The finder system may then present each of the located objects to the wanter who then selects a “winning” object. When the wanter selects a winning object, a location of the object is revealed to the wanter and the selected finder is paid. Now, an example of an implementation of the finder system is described in more detail.

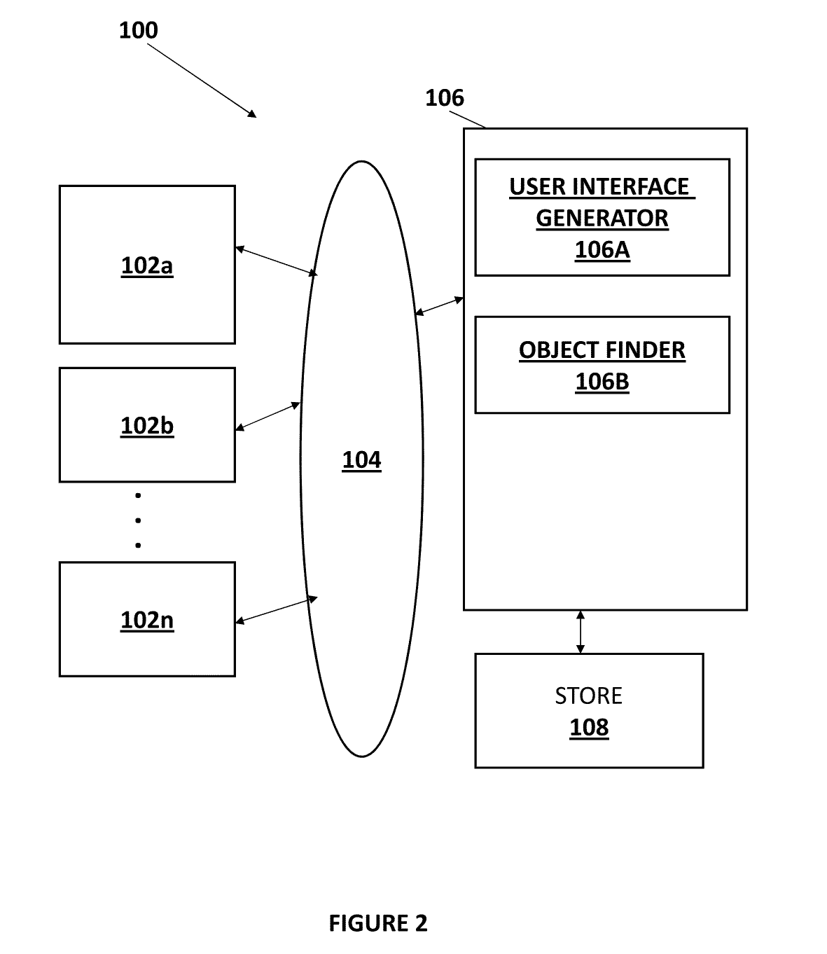

FIG. 2 illustrates details of an implementation of a finder system 100. The finder system 100 may have one or more computing devices 102, such as 102a, 102b, . . . , 102n, that are used by the wanter and the one or more finders to interact with the finder system. Each computing device may be a processing unit based device with a processing unit, display, memory and connectivity (wired or wireless) that allows it to interact with the finder system. Each computing device may have a browser application that is executed by the processing unit that interacts with the finder system using web pages in a client/server implementation of the finder system. Alternatively, each computing device may have a mobile application that is executed by the processing unit that interacts with the finder system in a cloud computing, software as a service or other implementations of the finder system. Each computing device may be, for example, a personal computer, a terminal, a laptop computer, a tablet computer, a smartphone device (Apple iPhone or Android OS based device) or a consumer electronics device that has connectivity and a display.

The one or more computing devices 102 may each have circuitry within the computing device that allows the computing device to connect to and communicate with the finder system over a link 104. The link 104 may be a wireless link or a wired link. The link 104 may be a cellular network, a digital data network, a cellular digital data network, a messaging network, a computer data network and the like.

The one or more computing devices 102 may each interact with a finder component 106 over the link 104. The finder component may be implemented as one or more server computers in a client/server implementation, one or more cloud computing resources in a cloud computing implementation and/or one or more computing resources for a software as a service implementation or a mobile application implementation. The finder component may have a user interface generator 106A and an object finder 106B and each of these components may be implemented in hardware or software. In a hardware implementation, each component may be a hardware circuit that performs a particular function, a programmable logic device and a memory. In a software implementation, each component may be a plurality of lines of computer code that may be executed by a processor of the computer system that is part of the object finder 106. The finder component may be coupled to a store 108 that stores the various user data (both for the wanter and the finders), wanted object identification data, found object data and the like that are used by the system. The store 108 may be a hardware or software based database system, a relational database system or other known storage systems. The wanter may be an entity that is looking for the object, such as a person, a corporation, another computer and the like. Each finder may be an entity that is trying to find the wanted object and each finder may be a person, a corporation, another computer and the like.

The user interface generator 106A may be a component that receives a request from a computing device 102 and generates a user interface based on the request. The user interface generator 106A may be implemented in hardware or software. For example, the user interface generator 106A may be a software or hardware implemented web server that delivers web pages in the client server implementation of the finder system or may be a software or hardware module that generates data that is used to generate a user interface on a mobile application of the computing device in other implementations. The object finder component 106B may perform an object location process between a wanter and one or more finders as described in more detail below and may be coupled to both the user interface generator 106A and the store 108. The object finder system may be used to find a plurality of objects for a plurality of wanters and may utilize a plurality of finders.

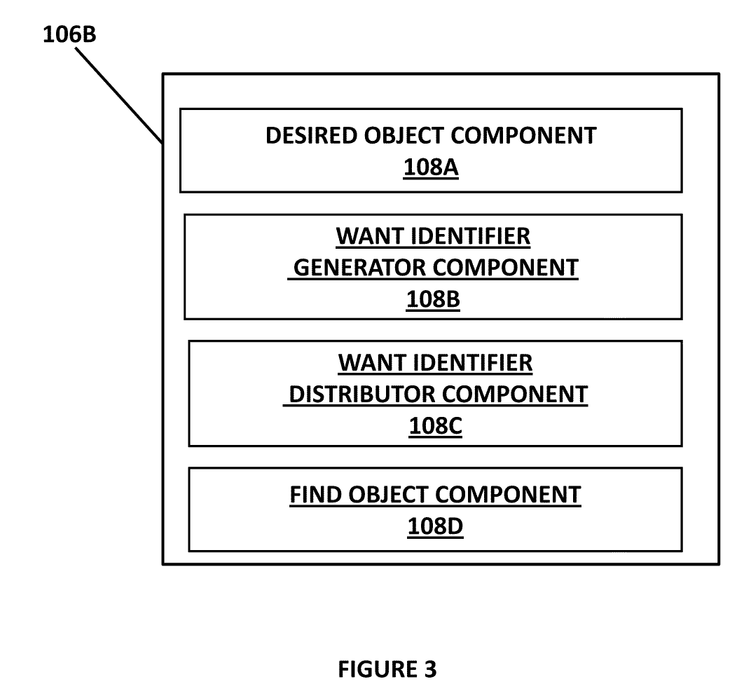

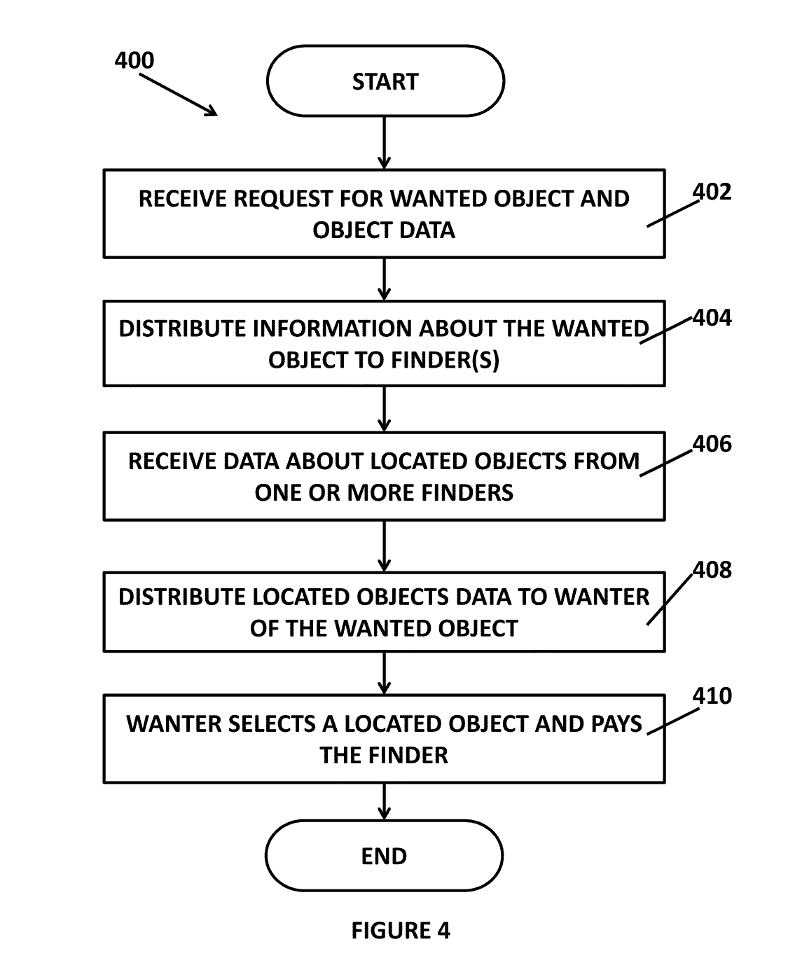

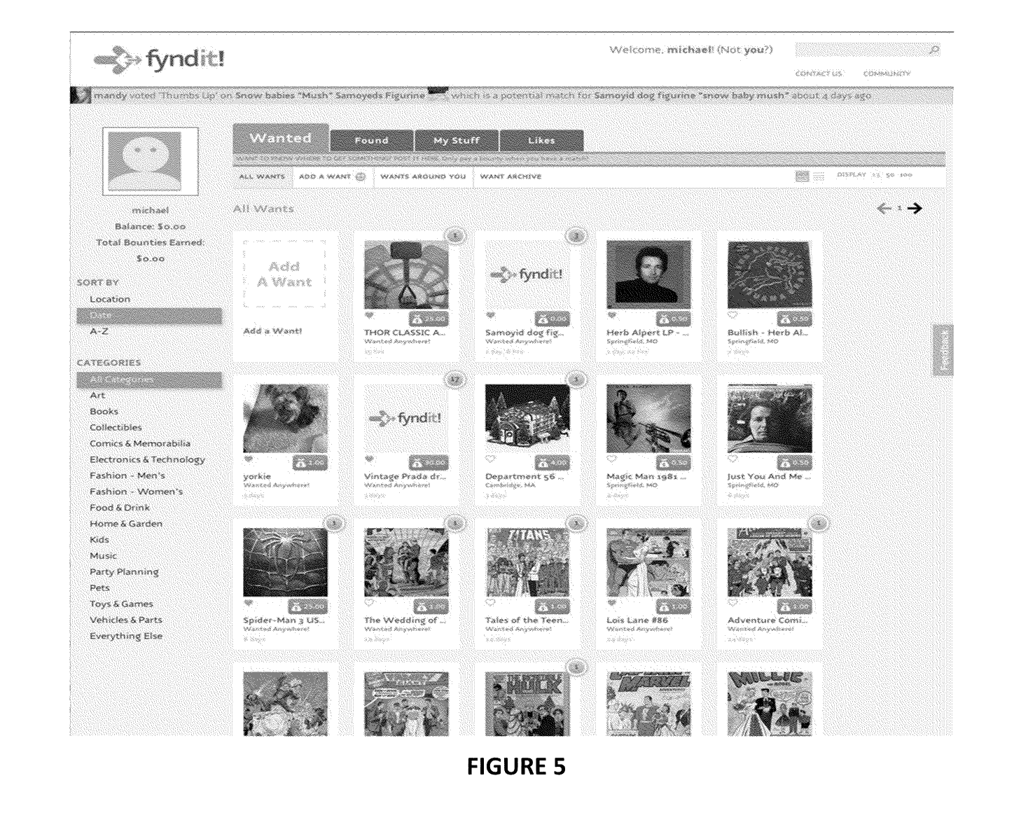

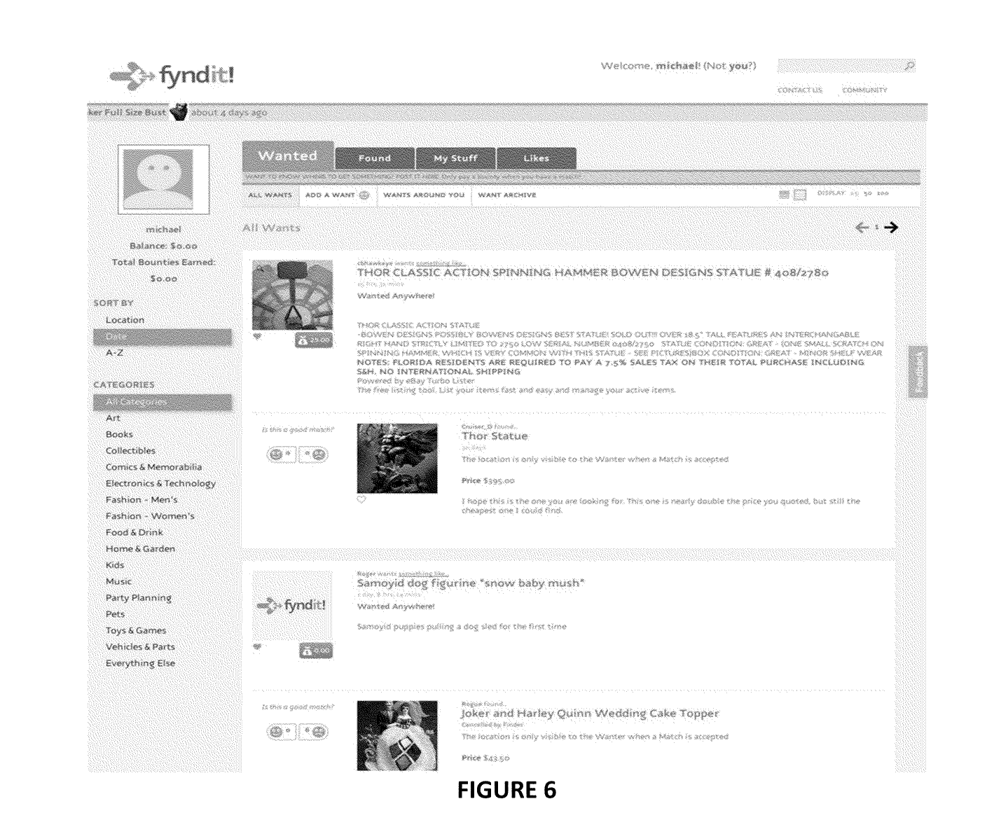

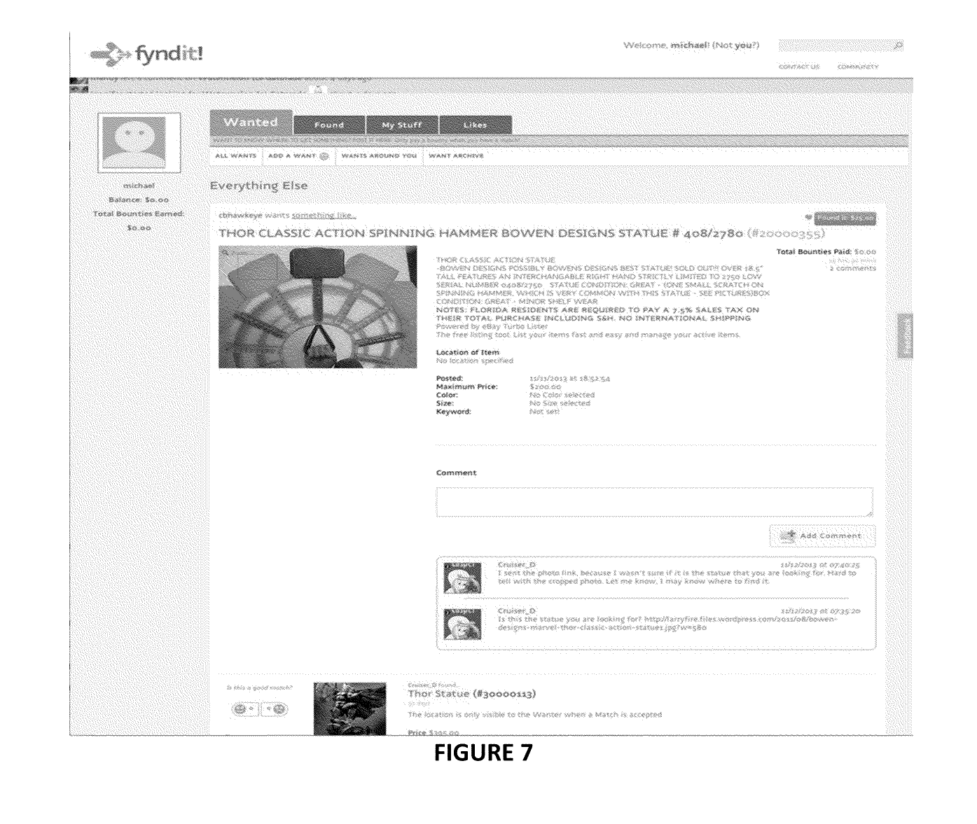

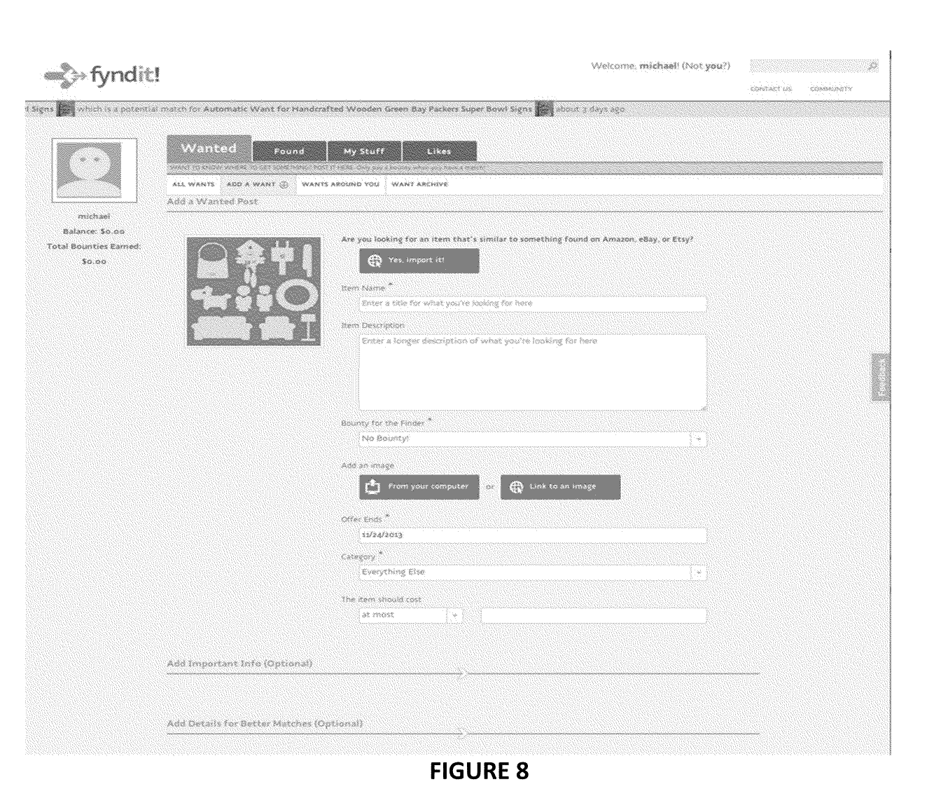

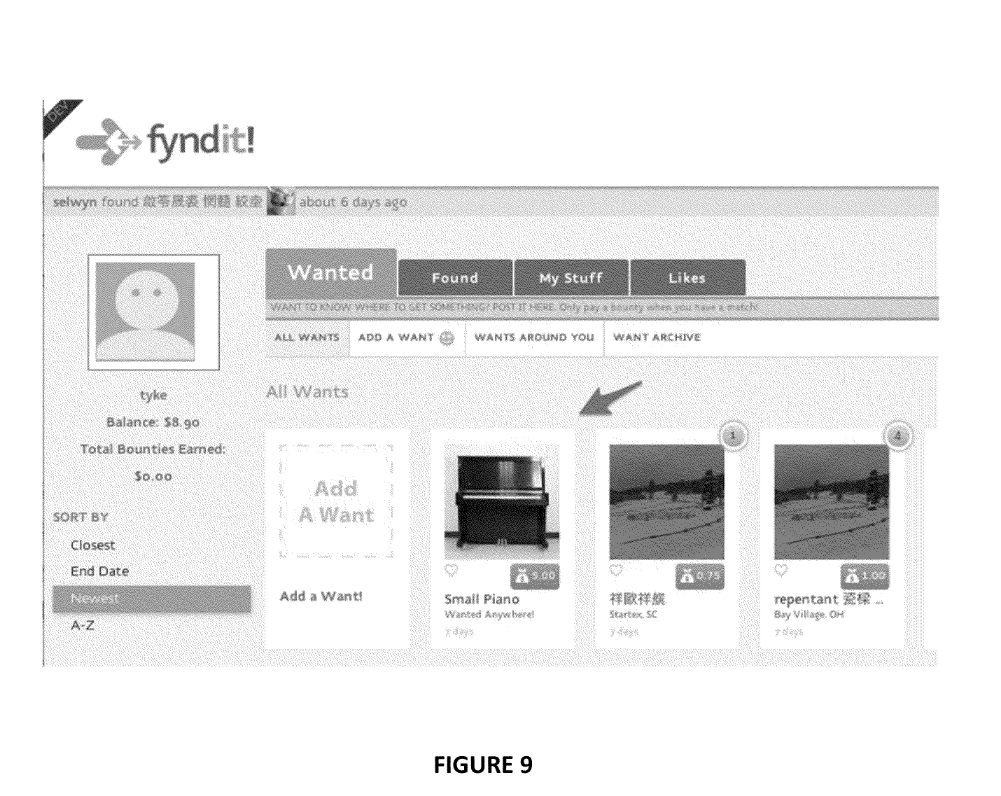

FIG. 3 illustrates more details of the object finder 106B in the finder system in FIG. 2 and FIG. 4 illustrates an example of a method 400 for finding an object that may be carried out by the system in FIG. 2. The object finder 106B may further one or more components in FIG. 3 that are coupled to each other to perform the object location process. Each component in FIG. 3 may be implemented in hardware or software. In a hardware implementation, each component may be a hardware circuit that performs a particular function, a programmable logic device and a memory. In a software implementation, each component may be a plurality of lines of computer code that may be executed by a processor of the computer system that is part of the object finder 106B. The object finder 106B may further comprise a desired object component 108A, a want identifier generator component 108B, a want identifier distributor component 108C and a find object component 108D. The desired object component 108A may receive (possibly via a user interface) a request to locate an object. The desired object component 108A may also request information about the wanted object (402). The information may be entered by the wanter (such as by using a computing device) and stored in the store 108. An example of the user interface for adding a want is shown in FIG. 8. The information may include, for example, one or more photographs or images of the object, a description of the object, key word(s) associated with the object and/or attributes of the object, such as color, size, etc.) Examples of the user interface with a list of wants are shown in FIGS. 5-7 and 9.

The desired object unit 108A may also receive information about a desired location of the desired object, a maximum distance from that location, and a location of the Wanter. The desired location may be a simple longitude and latitude, an address and/or more extensive information such as the name of a venue, it's description, it's hours of operation, or social media identifiers associated with the establishment. Some, or all, of this location and object information, may come from other services, such as FourSquare, Google Places, or Facebook. The desired object component 108A may also receive information about an amount of money (remuneration) the Wanter will pay for the location of the desired object (the “Tip” or “Bounty”). Typically, this is a relatively small amount of money ($0.50, $1.00, etc) since they are paying for the location of the object, not the object itself.

Based on the above information about the wanted object, the want identifier generator component 108B may associate a want identifier (“want ID”) with the wanted object. The “want ID” is a value unique within the object finding environment. For example, in one embodiment, the “want ID” may be a unique 64-bit unsigned integer. The want identifier distributor 108C of the object finder may then transmit (“publish”) the information about the wanted object to one or more destinations, including other users of the service, text messaging and social media such as Twitter and Facebook (the dissemination systems 92) (404.) The published information that is disseminated to each different destination may vary depending on the capabilities of the particular dissemination system. For example, Facebook would receive the Wanted item's photograph and description whereas Twitter—being a text-only service—would receive only text data.

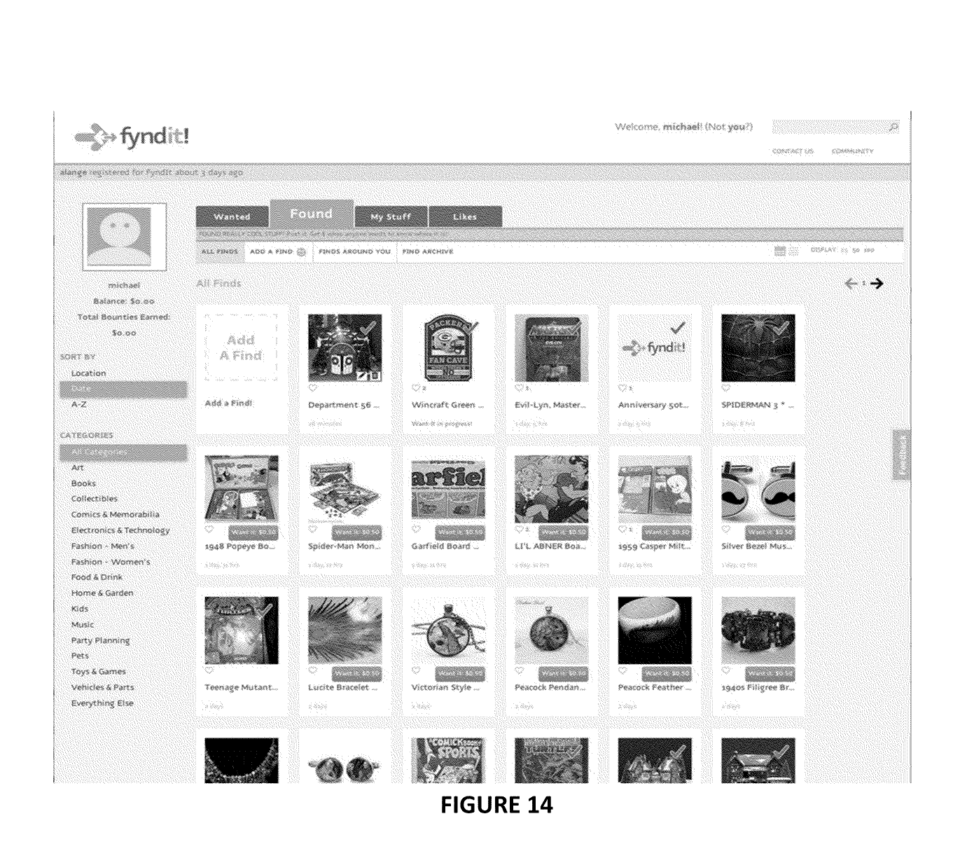

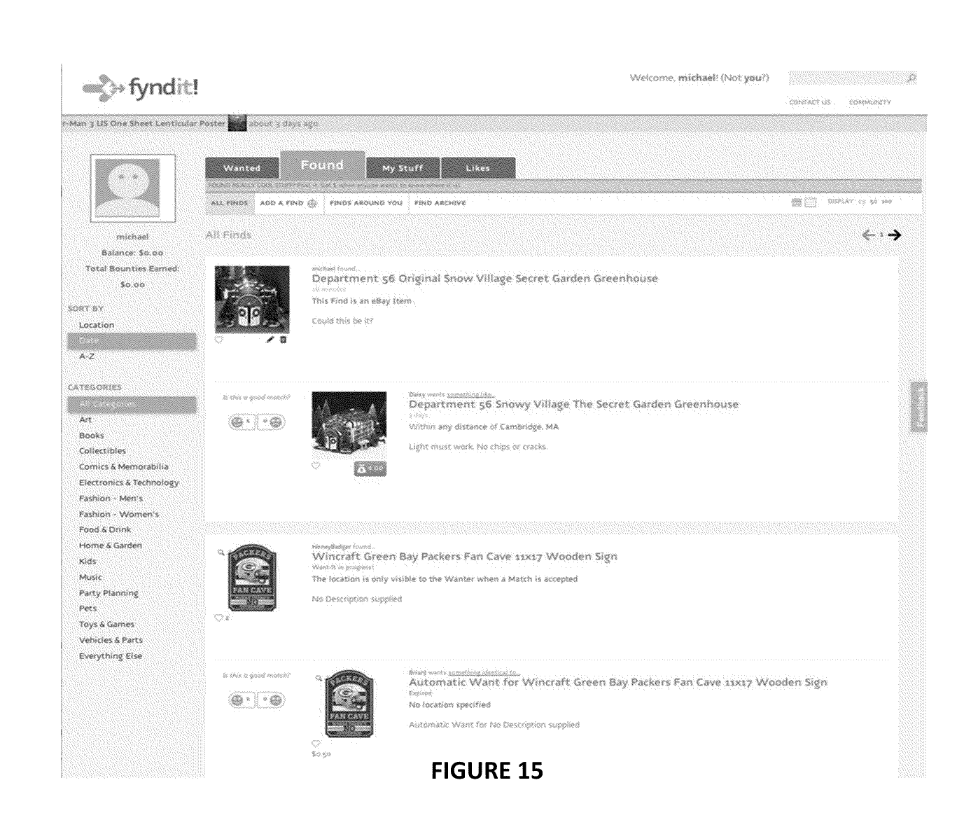

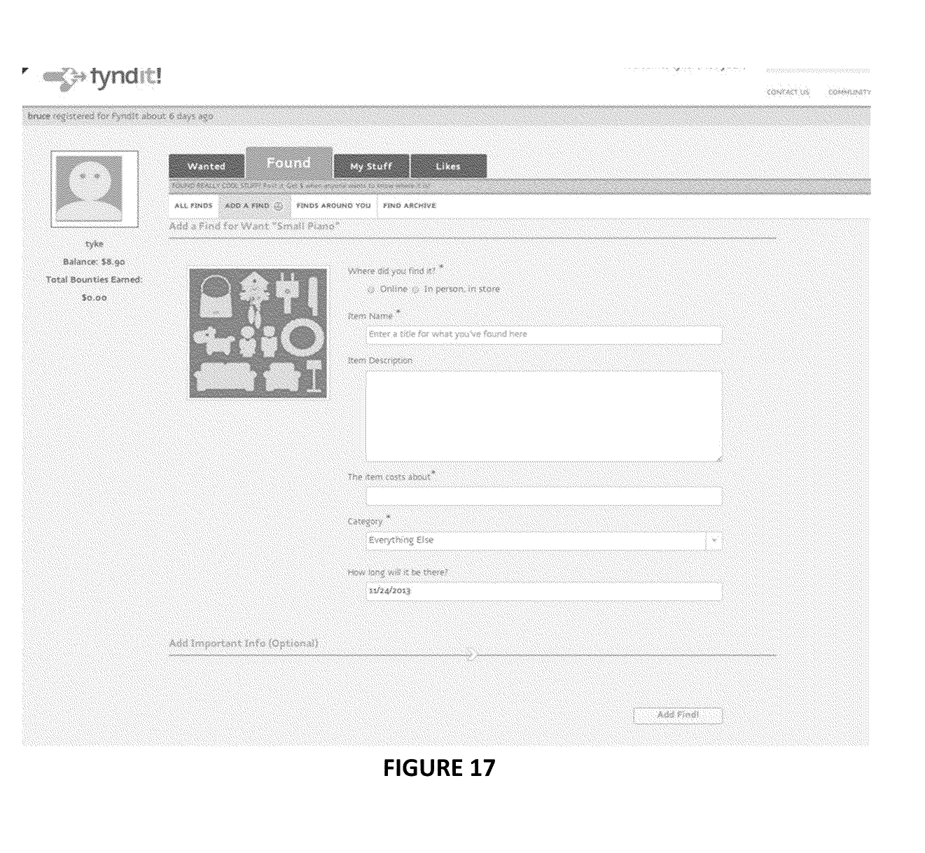

Once the want ID and the wanted object information has been distributed, one or more finders may believe that they know where to find an object or service matching the wanted object. Each finder may find this object in the real world, or on the internet. Each “Finder” may capture information about the potential “Find” and send it to the find object component 108D of the finder system using a computing device (406.) Examples of the user interface for a list of finds and a user interface to add a find as shown in FIGS. 14-15 and 17. The information about the find may also be stored in the store 108 with the want ID. The find object component 108D may also receive information about the potential find of the finder that may include, for example, one or more photographs or images of the object, a description of the object, key word(s) associated with the object and/or attributes of the object, such as color, size, etc.) The information on the found object may also include a location of the potential “Find”. The location information may be a simple longitude and latitude, an address, an online location, or more extensive information such as the name of a venue, it's description, it's hours of operation, or social media identifiers associated with the establishment. Some, or all, of this information, may come from other services, such as FourSquare, Google Places, or Facebook. The information about the found object may also be stored in the store 108. The finder system may associate the found object information for a particular finder with a “find ID” that may also be stored in the store 108 (a ‘find ID’ is also a value unique within the object finding environment) The finder system may also associates or matches the “find ID” with the “want ID” of the wanted object.

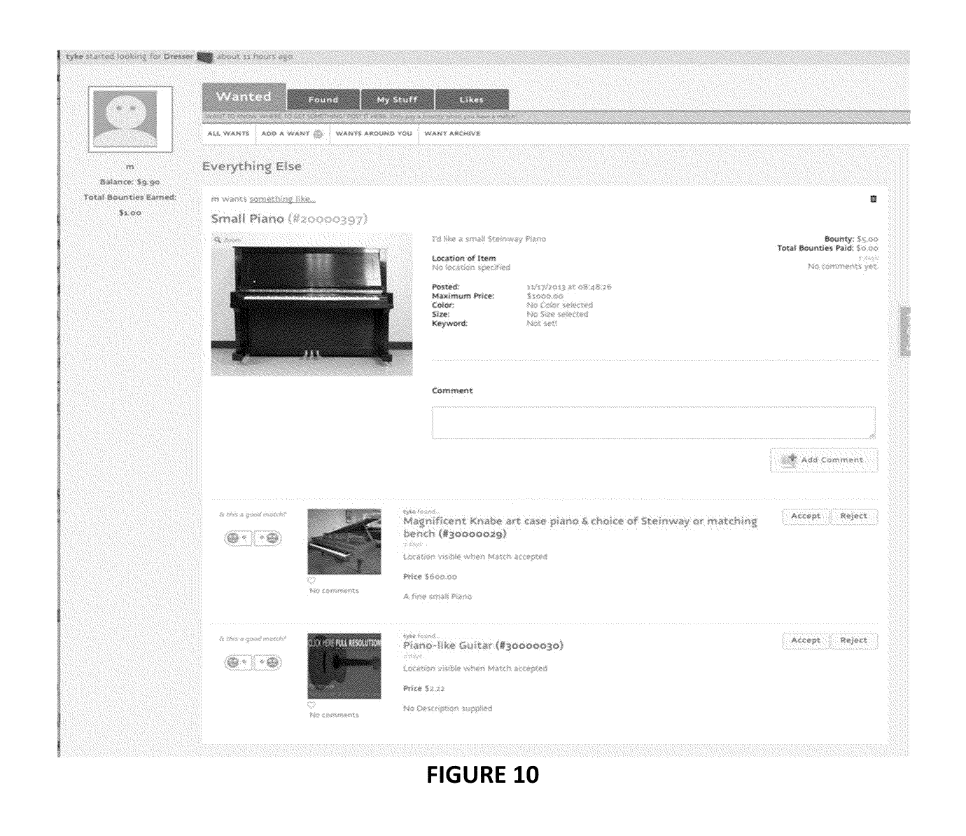

The object system 106B, using the dissemination system 92 may then transmit (“publish”) the information about the potential Find to the “Wanter” (the individual who created the “Want”) (408). An example of the user interface of a want with two finds is shown in FIG. 10. The object system 106B, using the dissemination system 92 may also publish the found object information to other destinations, such as SMS, Twitter, or Facebook.

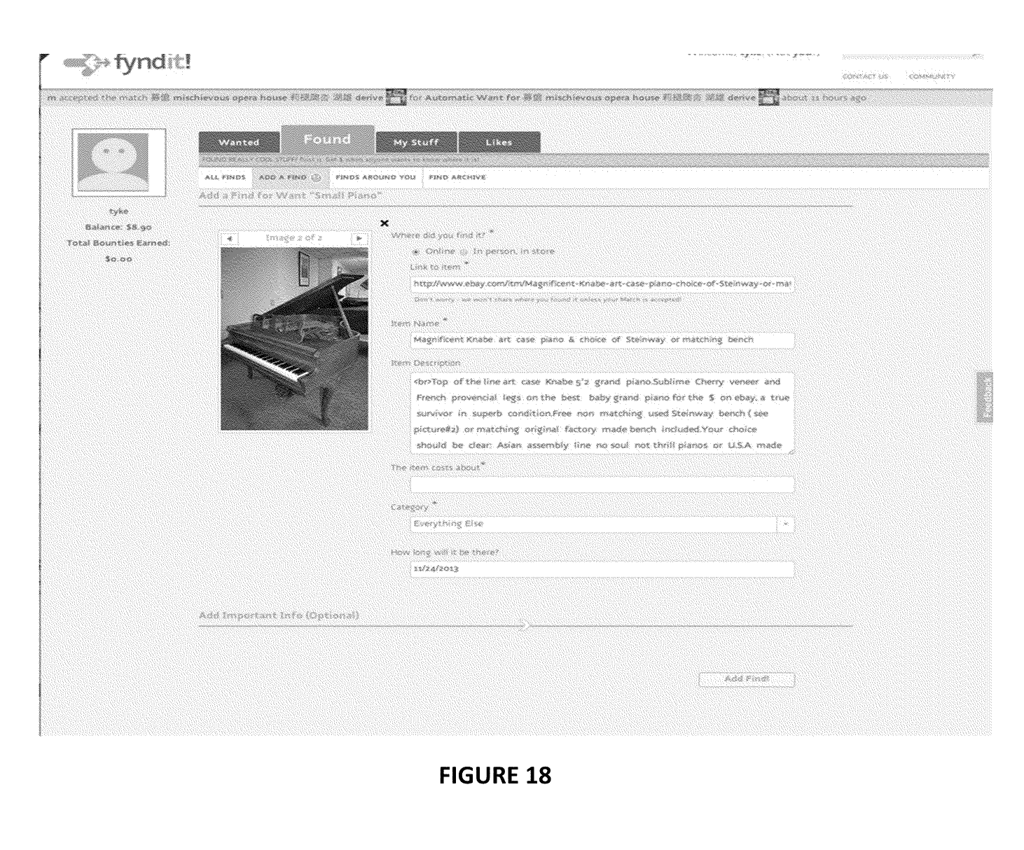

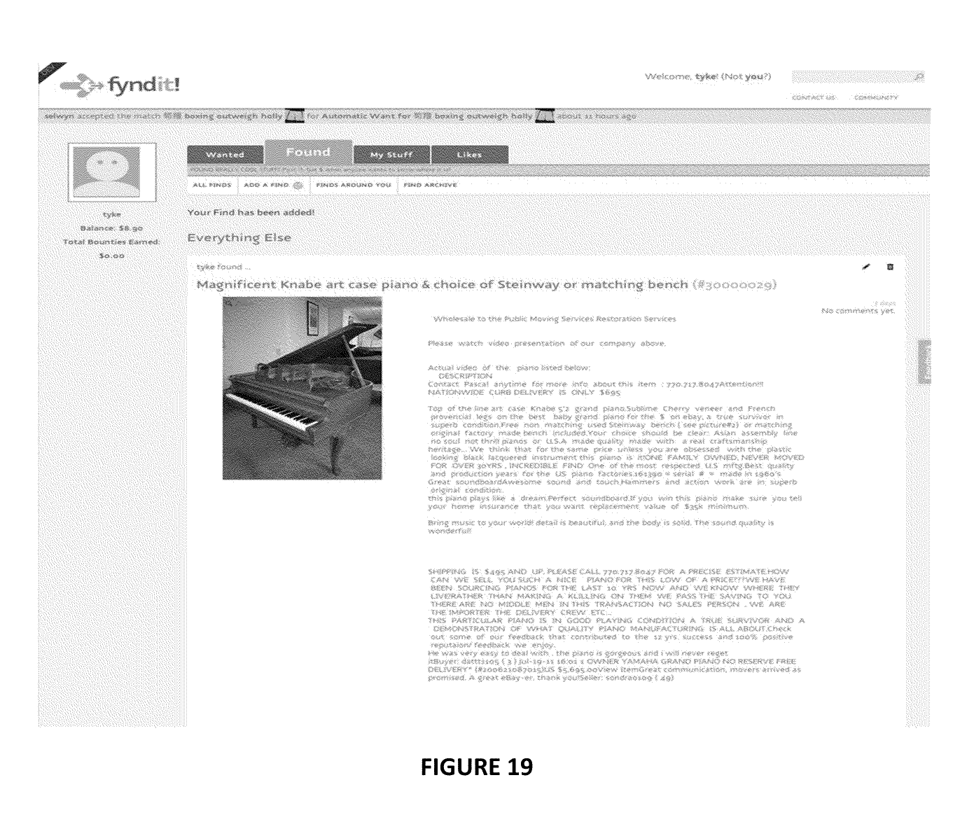

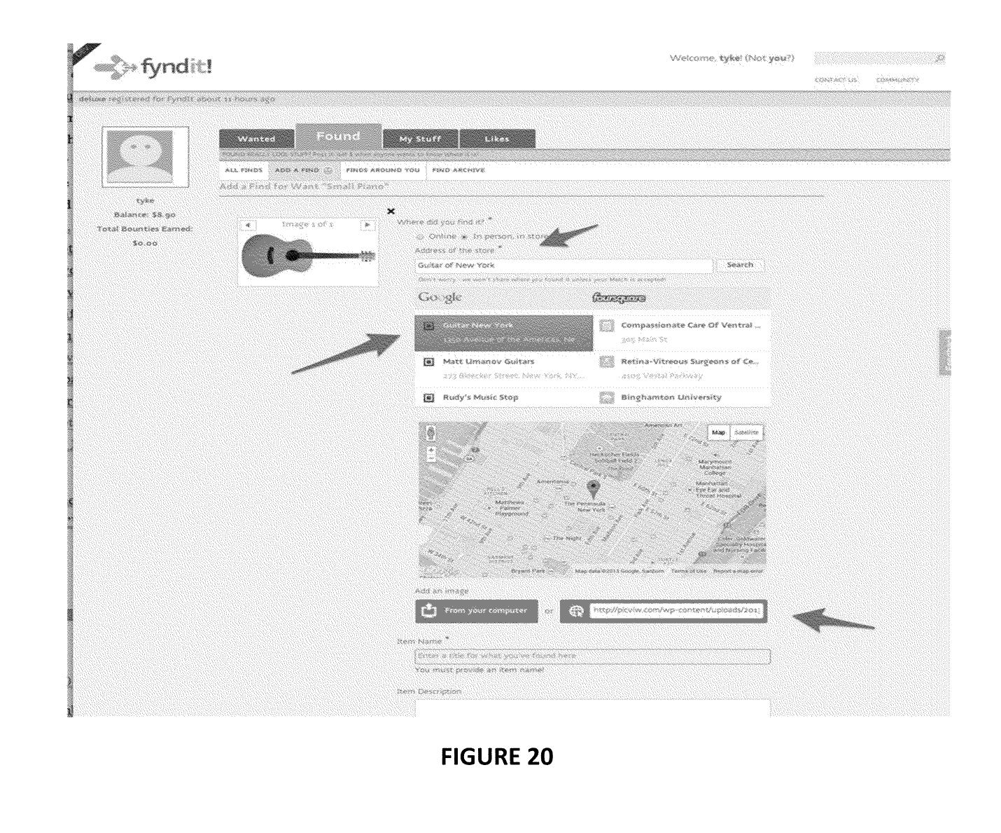

The finder system allows the process of “Finding” to occur any number of times. Thus, for each finder who finds the wanted object, the process of gathering and storing the found object information and the finder ID occurs and the distribution of the found object information for each finder is distributed. Thus, the system may present the wanter with a list of one or more finders who have found a location of the wanted object. The list of one or more finders displays found object information for each finder, but does not display the location of the found object. FIGS. 18-20 show examples of the user interface displaying a find from ebay (FIGS. 18-19) and from a store (FIG. 20.)

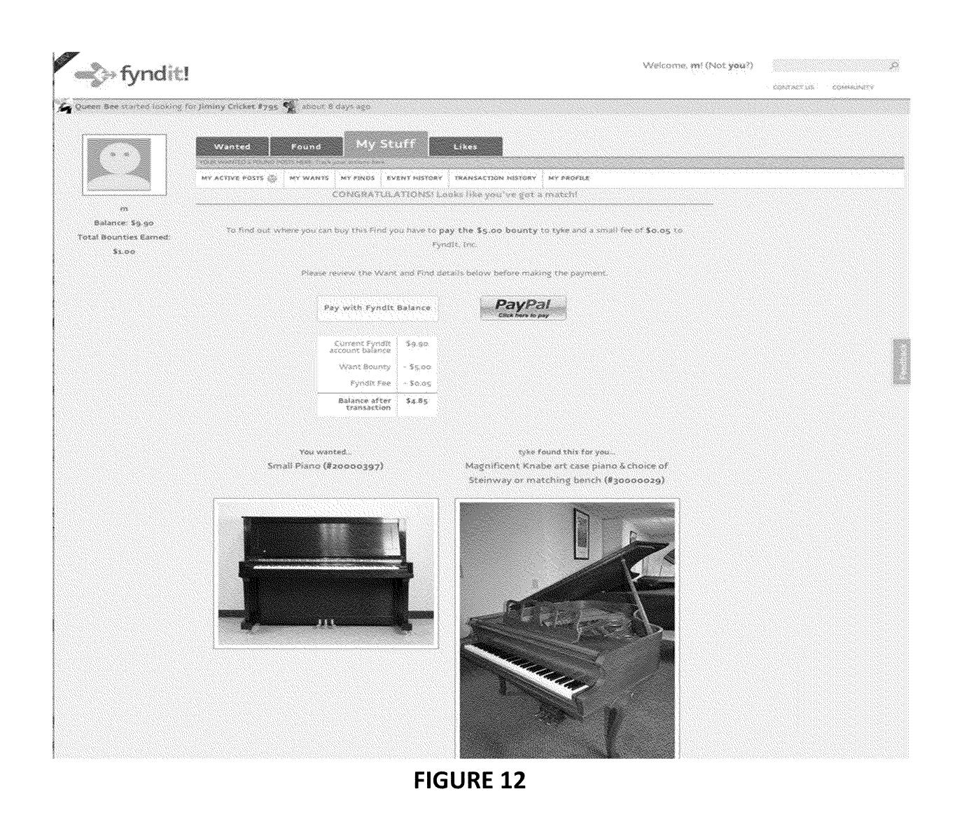

The “Wanter” may then examine the list of potential “Finds” to ascertain if any of them represent the desired object or service. The “Wanter” may then accept one or more of the “Finds” which are a match for their “Want” (410). An example of the user interface displaying accepting a find is shown in FIG. 12. The wanter may use the computing device to notify the object finder that the finder would like to accept the “Find”. The object finder, via the computing device, may remind the “Wanter” that, in order to get the Find's location, the wanter must pay the “Tip” described above. If the wanter agrees, the Wanter is charged the tip using any one of a number of methods of the payment systems 90, the Wanter's preferences for a payment platform, and the platforms available at the time.

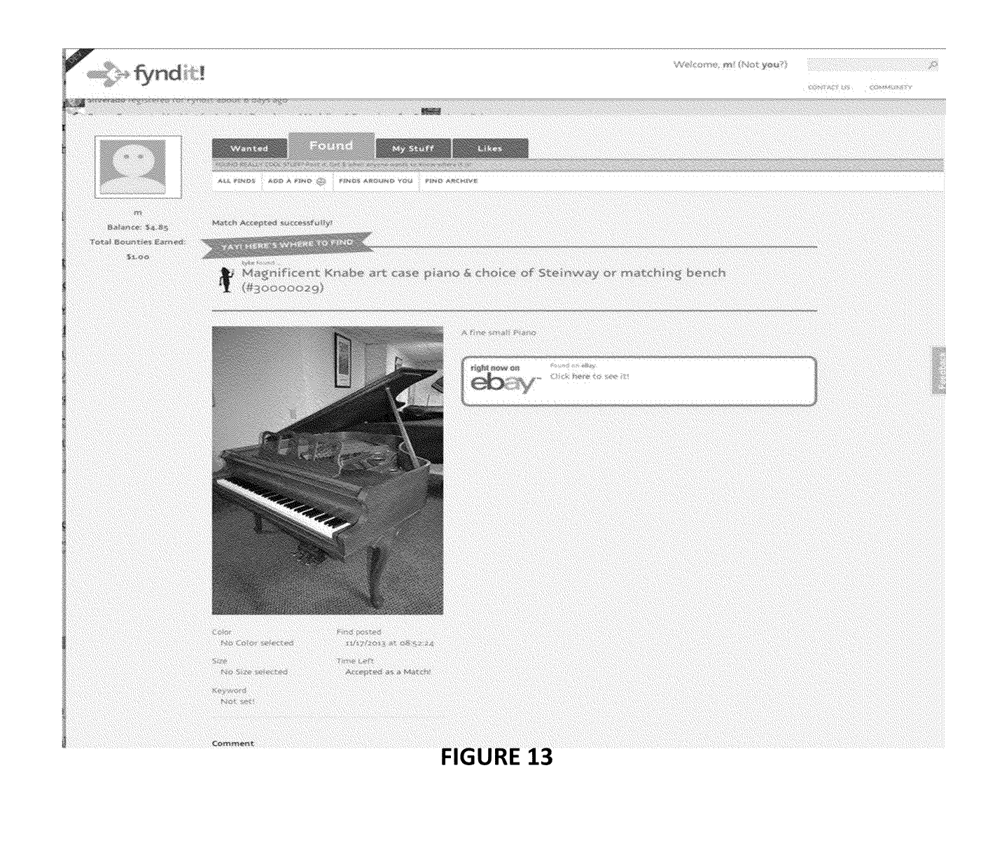

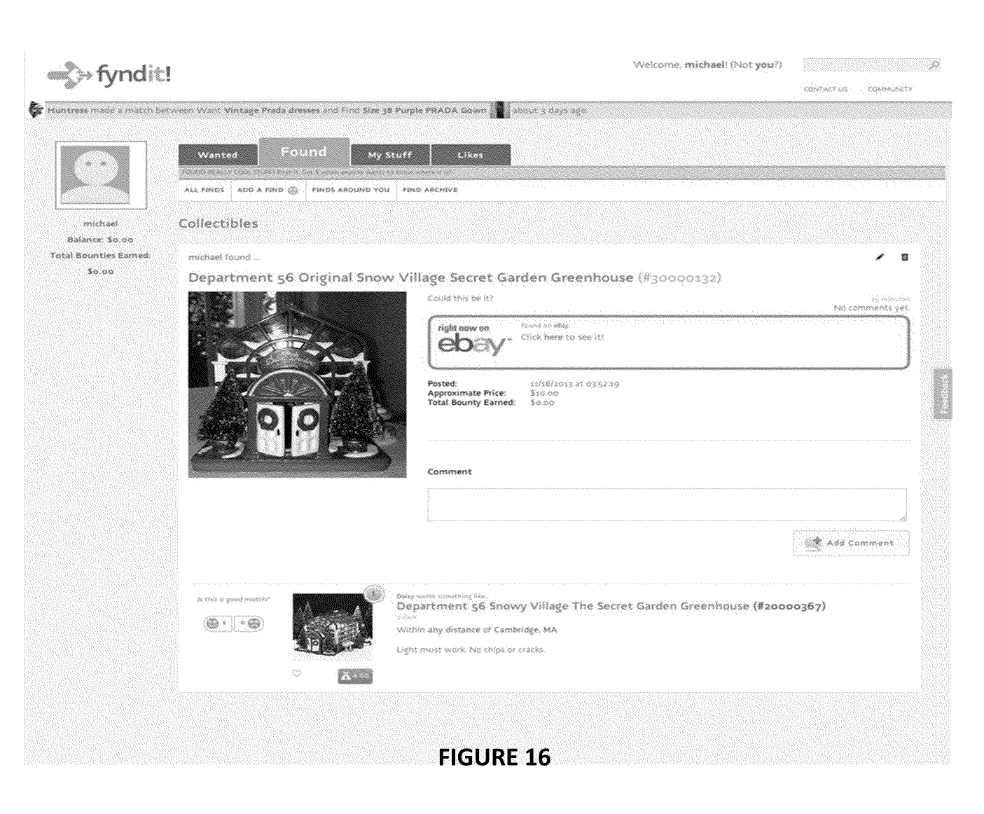

The result is that the Wanter is charged the Tip/Bounty, and the Tip/Bounty amount is credited to the Finder again using one of a number of payment methods. The tip amount charged, or credited, may be adjusted to allow for certain service charges by the Payment Provider and/or the System/Service described herein. Once the finder system has confirmed the exchange of funds between the wanter and the finder, the system may then reveal Find's exact location to the “Wanter”, along with any other venue information provided by the Finder. Example of the user interface displayed a completed accepted find for a want and a find with detailed location information are shown in FIGS. 13 and 16, respectively.

The Wanter may then proceed to the location and may purchase the desired object or service. Unlike the finding process above that may occur multiple times, the accepting of a find may only occur once.

Alternative Processes

In the above described process, the wanter identifies a wanted objects and the finders locate the wanted object. However, the finder system also may allow each finder to find objects that are unique, or could be of interest to other users of the service and the finder may capture information about the “Find” as described above that is stored in the system. As above, the system may also receive information about a location of the find. This type of found object may be known as a “Remnant”. In the system, a 3rd party known as a “Matcher”, who may not be the Finder or the Wanter, may decide that the Find is appropriate for a “Want” in the system and “Match” the Find to the Want. From this point on, the process proceeds as above in that the Wanter will Accept one or more Finds, the Tip/Bounty will be collected from the Wanter, and the Find's location will be revealed to the Wanter. In this alternative process, the Tip/Bounty may be split between the original Finder and the Matcher. For example, the Finder may get 90% of the Tip/Bounty, and the Matcher may get 10%. In this example, the object component in FIG. 3 may also have a find identifier component and a matching engine component that may be software or hardware as described above.

The system and method described above may also provide an ability for a member to filter notifications for wanted objects, found objects and the like. For example, a member who has a number of wanted objects can filter the notifications to only see notification for a particular wanted object.

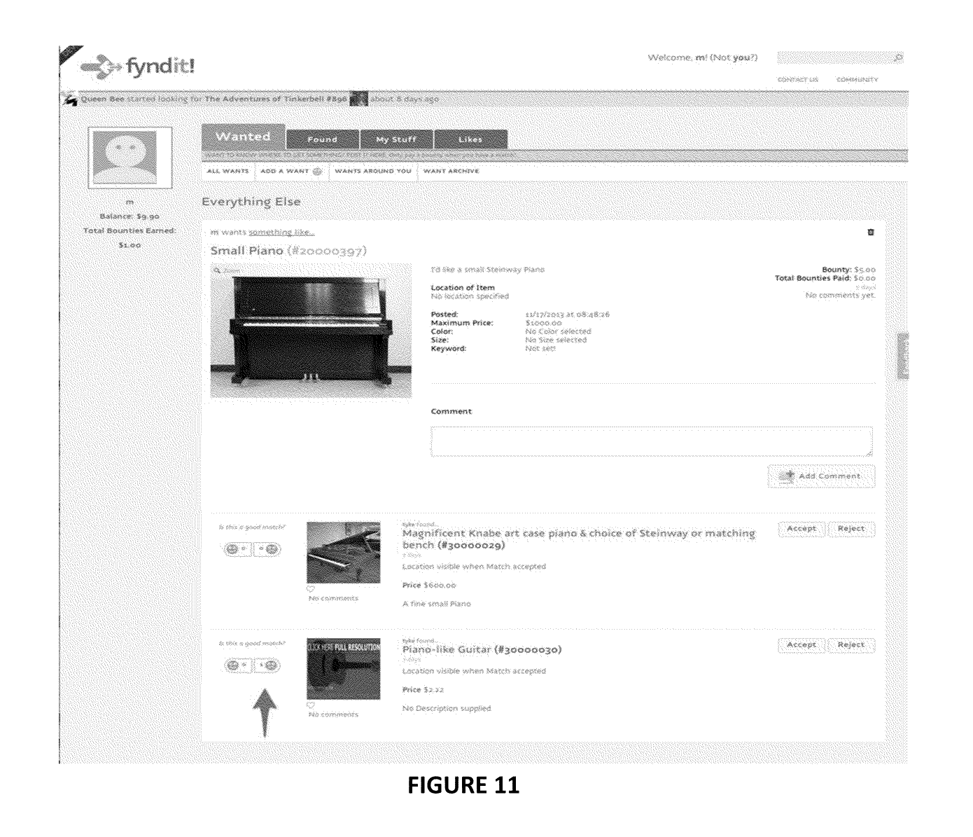

The system and method described above may also provide an ability for a member to “Like” a wanted object or a found object so that each member can indicate an appreciation for each. In other implementations, the system and method may also provide an ability for a member to give an approval or disapproval of a match or a vote using a voting component that is part of the system in FIG. 3 and may be implemented in hardware or software as described above. An example of the user interface in which a find has been voted down is shown in FIG. 11. In one implementation, the approval may be a “Thumbs Up” indication and the disapproval may be a “Thumbs Down” indication. For example, if a member wanted a piano, but a finder posted a guitar as a match, any registered member, including the person who wanted the piano, may indicate disapproval for the found guitar object. If the member wanted a piano and a finder posted a piano as a match, any registered member, including the person who wanted the piano, may indicate approval for the found piano object. In the system, there may or may not be a limit on the number of thumbs up or thumbs down votes an individual member may give. For example, each member may have unlimited votes, each member may be limited to one vote for a period of time, each member can have their right to vote controlled by some other qualification, such as how long the member has been registered with the service, etc. The system may maintain a count of the Thumbs up and down votes assigned to a match so as to aid the wanter by providing a “popular” or “social” view of the appropriateness of the Match. When a particular match gets a vote (up or down), the system may notify the object's creator, the member providing the vote, and people “interested” in Likes or Unlikes, Thumbs-Up or Thumbs-Down votes in the system. The notification could take place via Email, SMS, Apple Push Notifications, Facebook Posts, or any other method.

Want It Operation

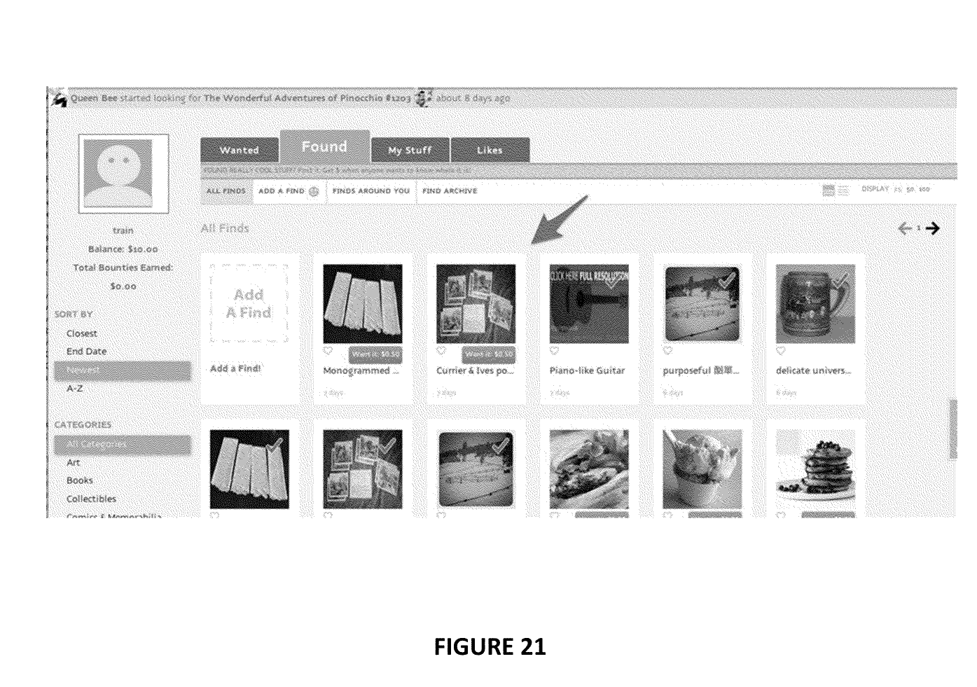

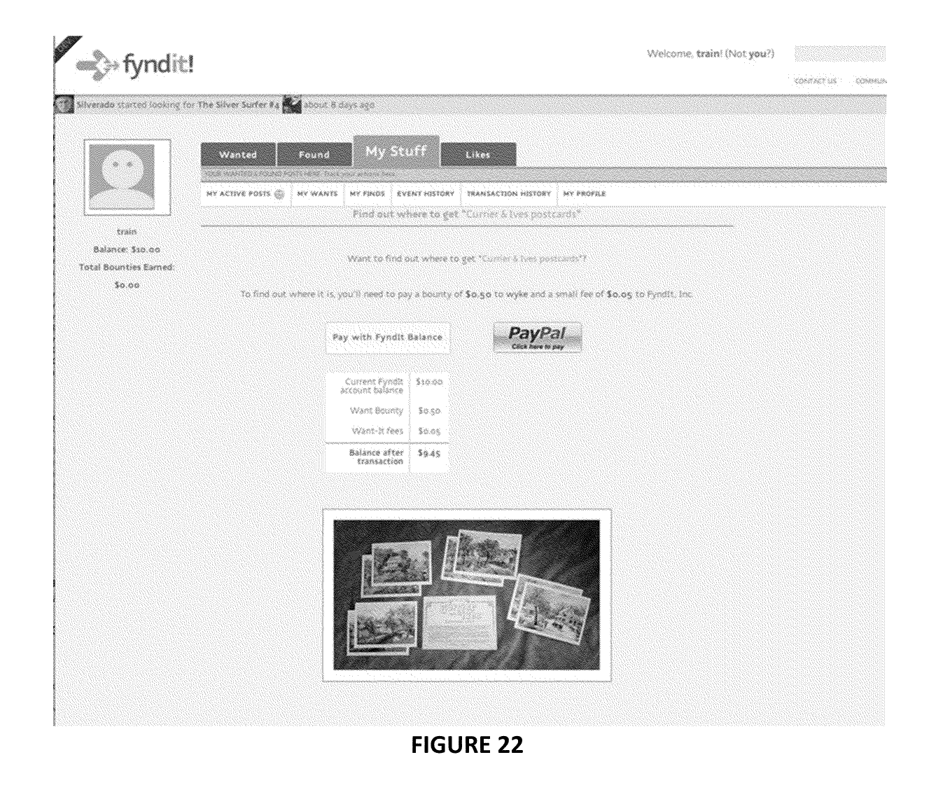

In the system, it is possible that a member may see a Find which they would like to have, even though they have not created a “Want” for it. In this case, the system may make available a “Want It” operation, which allows the member to pay the bounty as described above (along with any additional fees) to obtain the Find's location. Examples of the user interface with a list of Want It items are shown in FIGS. 21-22. The operation is exactly equivalent to the member creating a Want, having the Find matched to it, and the member accepting the match. However, the system may impose limitations on which Finds may allow a “Want It” operation. For example, image that a third party, who is not a Wanter or a Finder, sees a find for a guitar in the system which they would really like to have. This find can either be a “remnant” (see above) or a find posted in response to a want. By pressing the “Want It” button on the find and paying the tip/bounty, the third party can conveniently learn the location of the guitar and purchase it.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A system, comprising:
a computer having a processor;
a finder component, executed by the processor of the computer, that receives one or more pieces of information about a wanted object from a first entity who wants the wanted object, the wanted object having the one or more pieces of information that describe the wanted object; and
the finder component having a want identifier component that generates a want identifier for the wanted object, the want identifier for the object having an amount of money that is being offered by the first entity for the wanted object, a want publisher component that distributes the want identifier for the wanted object to a plurality of second entities and each second entity knows a location of the wanted object based on the want identifier and sends a located object identifier including the location of the object to the finder component, and a found object component that distributes one or more located object identifier to the first entity so that the first entity selects a particular located object identifier and pays the second entity that is associated with the particular located object identifier.

2. The system of claim 1 further comprising a payment system that allows the first entity to pay the second entity associated with the particular located object identifier the amount of money for the wanted object.

3. The system of claim 1, wherein the finder component has a voting component that permits each of the plurality of second entities to vote on a particular located object identifier.

4. The system of claim 1, wherein the one or more pieces of information about a wanted object are one or more of a photograph or image of the wanted object, a description of the wanted object, one or more key words associated with the wanted object and one or more attributes of the wanted object.

5. The system of claim 4, wherein the one or more pieces of information about a wanted object are one or more of a desired location of the wanted object, a maximum distance from that location of the wanted object and a location of the first entity.

6. The system of claim 1 further comprising a computing device for the first entity and each second entity, wherein the computing device sends and receives data with the finder component.

7. The system of claim 6, wherein each computing device is one of a personal computer, a laptop computer and a smartphone device.

8. The system of claim 1, wherein the finder component reveals the location of the wanted object in the located object identifier to the first entity only after the first entity has paid the second entity.

9. A method for object location of a wanted object by a first entity that wants the wanted object, the wanted object having one or more pieces of information that describe the wanted object that are part of a want identifier and a second entity, the method comprising:
receiving, at a computer based finder system, one or more pieces of information about a wanted object from the first entity;
generating, by the finder system, a want identifier for the object, the want identifier for the object having an amount of money that is being offered by the first entity for the wanted object;
distributing the want identifier to a plurality of second entities;
receiving a located object identifier from the second entity that knows a location of the wanted object based on the want identifier, the located object identifier including the location of the object to the finder system; and
distributing the located object identifier to the first entity so that the first entity selects a particular located object identifier and pays the second entity that is associated with the particular located object identifier.

10. The method of claim 9 further comprising voting, by the plurality of second entities, on a particular located object identifier.

11. The method of claim 9, wherein the one or more pieces of information about a wanted object are one or more of a photograph or image of the wanted object, a description of the wanted object, one or more key words associated with the wanted object and one or more attributes of the wanted object.

12. The method of claim 11, wherein the one or more pieces of information about a wanted object are one or more of a desired location of the wanted object, a maximum distance from that location of the wanted object and a location of the first entity.

13. The method of claim 9 further comprising revealing the location of the wanted object in the located object identifier to the first entity only after the first entity has paid the second entity.

14. A method for object location, comprising:
receiving, at a computer based finder system, one or more pieces of information about a found object from a first entity that finds an object, the found object having one or more pieces of information that describe the found object including a location of the found object;
generating, by the finder system, a find identifier for the found object based on the one or more pieces of information that describe the found object;
matching, by a second entity, the found object to a wanted object of a third entity;
facilitating, by the finder system, a payment of an amount of money from the third entity to the first entity and second entity; and
revealing, when the payment of the amount of money is completed, the location of the found object to the third entity.

15. The method of claim 14, wherein the one or more pieces of information about a wanted object are one or more of a photograph or image of the wanted object, a description of the wanted object, one or more key words associated with the wanted object and one or more attributes of the wanted object.

16. The method of claim 15, wherein the one or more pieces of information about a wanted object are one or more of a desired location of the wanted object, a maximum distance from that location of the wanted object and a location of the first entity.

17. A system, comprising:
a computer having a processor;
a finder component, executed by the processor of the computer, that receives one or more pieces of information about a found object from a first entity that finds an object, the found object having one or more pieces of information that describe the found object including a location of the found object; and
the finder component having a find identifier component that generates a find identifier for the found object based on the one or more pieces of information that describe the found object, a matching engine that allows a second entity to match the found object to a wanted object of a third entity, a payment system that facilitates a payment of an amount of money from the third entity to the first entity and second entity and the finder component reveals, when the payment of the amount of money is completed, the location of the found object to the third entity.

18. The system of claim 17, wherein the finder component has a voting component that permits each of the plurality of second entities to vote on a particular located object identifier.

19. The system of claim 17, wherein the one or more pieces of information about a wanted object are one or more of a photograph or image of the wanted object, a description of the wanted object, one or more key words associated with the wanted object and one or more attributes of the wanted object.

20. The system of claim 19, wherein the one or more pieces of information about a wanted object are one or more of a desired location of the wanted object, a maximum distance from that location of the wanted object and a location of the first entity.

21. The system of claim 17 further comprising a computing device for the first entity and each second entity, wherein the computing device sends and receives data with the finder component.

22. The system of claim 21, wherein each computing device is one of a personal computer, a laptop computer and a smartphone device.
